(19) United States
(12) Patent Application Publication
(10) Pub. No.: US 2010/0265185 A1
(43) Pub. Date: Oct. 21, 2010

(54) Method and Apparatus for Performing Operations Based on Touch Inputs

(75) Inventor: Olli-Matti Oksanen, Helsinki (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/426,030

(22) Filed: Apr. 17, 2009

(51) Int. Cl. G06F 3/041

(52) U.S. Cl. 345/173

(57) ABSTRACT

An apparatus that may include a processor configured to receive a first touch input associated with a first contact region, perform a first operation based at least in part on the first touch input and size of the first contact region, receive a second touch input associated with a second contact region, and perform a second operation based at least in part on the second touch input and size of the second contact region is disclosed. A corresponding method, computer readable medium, and computer program product are also disclosed.

### RELATED APPLICATIONS

This application relates to U.S. Patent Application, entitled “METHOD AND APPARATUS FOR PERFORMING SELECTION BASED ON A TOUCH INPUT,” which is being filed concurrently and is hereby incorporated by reference in its entirety.

### TECHNICAL FIELD

The present application relates generally to touch input.

### BACKGROUND

There has been a recent surge in the use of touch displays on electronic devices. The user may provide input to the electronic device to perform various operations.

### SUMMARY

Various aspects of examples of the invention are set out in the claims.

According to a first aspect of the invention, an apparatus comprising a processor configured to receive an indication of a first touch input associated with a first contact region, perform a first operation based at least in part on the first touch input and size of the first contact region, receive an indication of a second touch input associated with a second contact region, and perform a second operation based at least in part on the second touch input and size of the second contact region is disclosed.

According to a second aspect of the invention, a method comprising receiving an indication of a first touch input associated with a first contact region, performing a first operation based at least in part on the first touch input and size of the first contact region, receiving an indication of a second touch input associated with a second contact region, and performing a second operation based at least in part on the second touch input and size of the second contact region is disclosed.

According to a third aspect of the invention, a computer program product comprising a computer-readable medium bearing computer program code embodied therein for use with a computer, the computer program code comprising code for receiving an indication of a first touch input associated with a first contact region, code for performing a first operation based at least in part on the first touch input and size of the first contact region, code for receiving an indication of a second touch input associated with a second contact region, and code for performing a second operation based at least in part on the second touch input and size of the second contact region is disclosed.

According to a fourth aspect of the invention, a computer-readable medium encoded with instructions that, when executed by a computer, perform receiving an indication of a first touch input associated with a first contact region, performing a first operation based at least in part on the first touch input and size of the first contact region, receiving an indication of a second touch input associated with a second contact region, and performing a second operation based at least in part on the second touch input and size of the second contact region is disclosed.

### BRIEF DESCRIPTION OF THE DRAWINGS

For a more complete understanding of example embodiments of the present invention, reference is now made to the following descriptions taken in connection with the accompanying drawings in which:

FIGS. 1A-1J are diagrams illustrating a contact associated with a touch input;

FIGS. 2A-2D are diagrams illustrating a contact region associated with a touch input;

FIG. 3 is a flow diagram showing a set of operations for performing operations based on touch inputs according to an example embodiment of the invention;

FIG. 4 is a flow diagram showing another set of operations for performing operations based on touch inputs according to an example embodiment of the invention;

FIGS. 5A-5E are diagrams illustrating input from a touch display according to an example embodiment of the invention; and

FIG. 6 is a block diagram showing an apparatus according to an example embodiment of the invention.

### DETAILED DESCRIPTION OF THE DRAWINGS

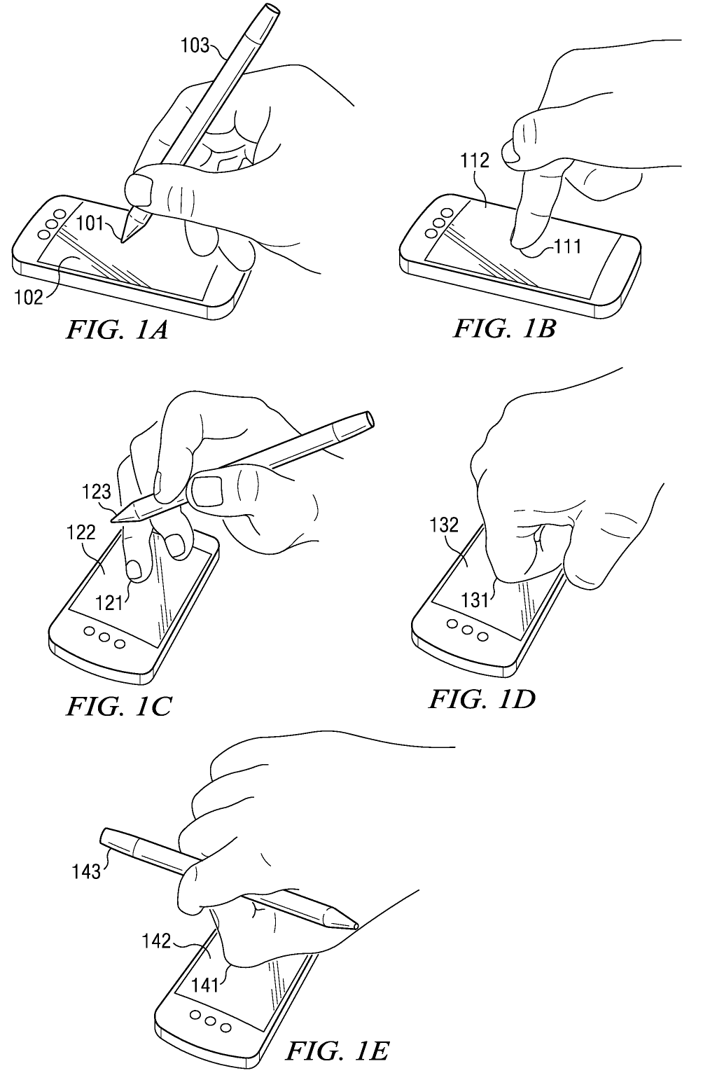

An example embodiment of the invention and its potential advantages are understood by referring to FIGS. 1A through 6 of the drawings.

In an example embodiment, a user provides touch input to an apparatus using various contacts with the touch display. In such an embodiment, the apparatus may perform different operations based upon the different contacts.

FIGS. 1A-1J are diagrams illustrating a contact associated with a touch input. The examples of FIGS. 1A-1J are merely examples of contacts and do not limit the invention. For example, a different body part, such as a wrist, elbow, foot, toe, chin, shoulder, and/or the like may contact the touch display and serve as the touch input. In another example, a different object, such as a book, a card, a ball, and/or the like, may contact the touch display and provide the touch input.

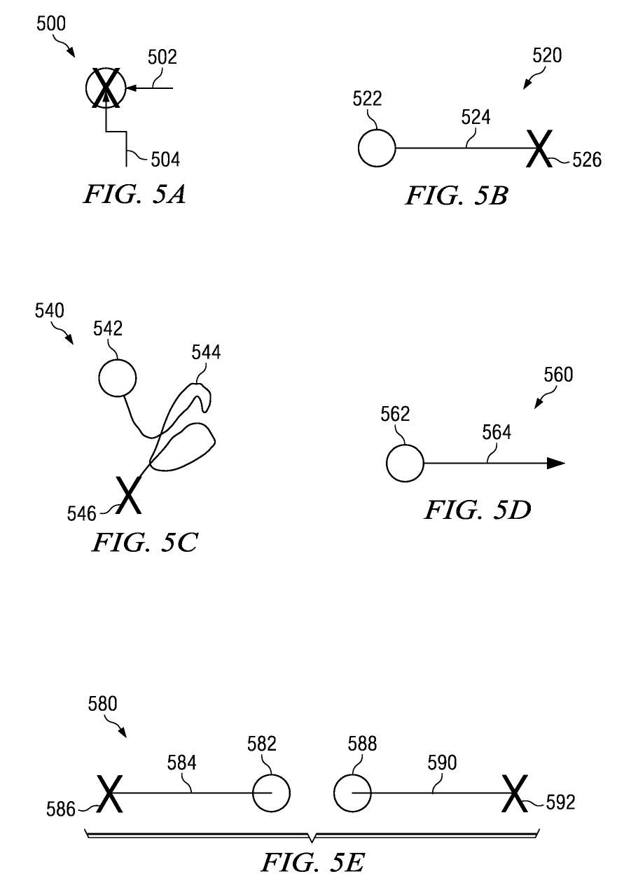

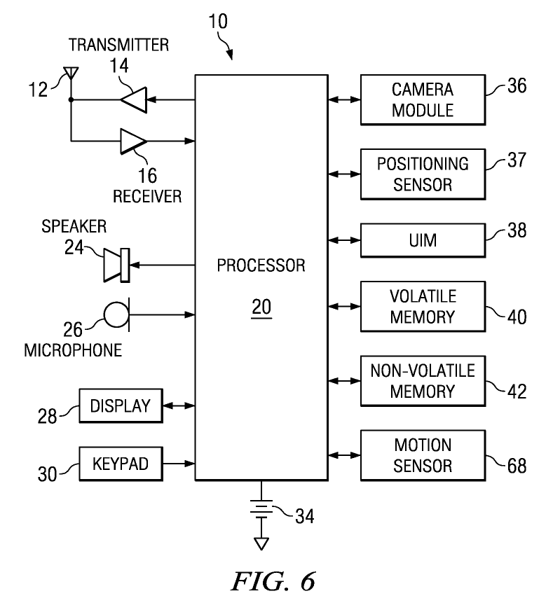

FIG. 1A is a diagram illustrating a tip 101 of a stylus 103 contacting a touch display 102, such as touch display 28 of FIG. 6, associated with a touch input, such as touch input 500 of FIG. 5A. Stylus 103 may be a device designed to be a stylus, or may be a device merely used as a stylus, such as a pen, a pencil, a pointer, and/or the like.

FIG. 1B is a diagram illustrating a finger tip 111 contacting a touch display 112, such as touch display 28 of FIG. 6, associated with a touch input, such as touch input 520 of FIG. 5B. Although the example of FIG. 1B illustrates the tip of an index finger, one or more other finger tips, such as the middle finger tip, may perform contact.

FIG. 1C is a diagram illustrating a finger tip 121 contacting a touch display 122, such as touch display 28 of FIG. 6, associated with a touch input, such as touch input 540 of FIG. 5C. In the example of FIG. 1C, the hand of the finger tip performing the contact holds a stylus 123. Stylus 123 may be a device designed to be a stylus, or may be a device merely used as a stylus, such as a pen, a pencil, a pointer, and/or the like. Although the example of FIG. 1C illustrates the tip of a ring finger, one or more other finger tips, such as a thumb tip, may perform contact.

FIG. 1D is a diagram illustrating a finger knuckle 131 contacting a touch display 132, such as touch display 28 of FIG. 6, associated with a touch input, such as touch input 560 of FIG. 5D. Although the example of FIG. 1D illustrates the knuckle of an index finger, one or more other finger knuckles, such as the middle finger knuckle, may perform contact.

FIG. 1E is a diagram illustrating a thumb knuckle 141 contacting a touch display 142, such as touch display 28 of FIG. 6, associated with a touch input, such as touch input 500 of FIG. 5A. In the example of FIG. 1E, the hand of the thumb knuckle performing the contact holds a stylus 143. Stylus 143 may be a device designed to be a stylus, or may be a device merely used as a stylus, such as a pen, a pencil, a pointer, and/or the like. Although the example of FIG. 1E illustrates the knuckle of a thumb, one or more other finger knuckles, such as the pinky knuckle, may perform contact.

FIG. 1F is a diagram illustrating a back 151 of a stylus 153 contacting a touch display 152, such as touch display 28 of FIG. 6, associated with a touch input, such as touch input 520 of FIG. 5B. Stylus 153 may be a device designed to be a stylus, or may be a device merely used as a stylus, such as a pen, a pencil, a pointer, and/or the like.

FIG. 1G is a diagram illustrating a finger pad 161 contacting a touch display 162, such as touch display 28 of FIG. 6, associated with a touch input, such as touch input 540 of FIG. 5C. In an example embodiment, the pad of a finger relates to a region of the finger between the tip of the finger and the joint of the finger closest to the tip. Although the example of FIG. 1G illustrates the pad of an index finger, one or more other finger pads, such as the middle finger pad, may perform contact.

FIG. 1H is a diagram illustrating a thumb pad 171 contacting a touch display 172, such as touch display 28 of FIG. 6, associated with a touch input, such as touch input 560 of FIG. 5D. In an example embodiment, the pad of a thumb relates to a region of the thumb between the tip of the thumb and the joint of the thumb closest to the tip.

FIG. 1I is a diagram illustrating a majority part of finger 181 contacting a touch display 182, such as touch display 28 of FIG. 6, associated with a touch input, such as touch input 500 of FIG. 5A. In an example embodiment, the majority part of the finger relates to a region of the finger between the tip of the finger and a joint of the finger at least two joints away from the tip of the finger. Even though the example of FIG. 1I illustrates the bottom of the finger contacting the touch display, other faces, such as the back, of the finger may contact the touch display.

FIG. 1J is a diagram illustrating a majority part of finger 191 contacting a touch display 192, such as touch display 28 of FIG. 6, associated with a touch input, such as touch input 520 of FIG. 5B. In an example embodiment, the majority part of the finger relates to a region of the finger between the tip of the finger and a joint of the finger at least two joints away from the tip of the finger. Even though the example of FIG. 1J illustrates the side of the finger contacting the touch display, other faces, such as the back, of the finger may contact the touch display.

In an example embodiment, a user may vary operations, such as information selection, information modification, displaying a virtual keypad, navigating a computer program, starting a program, terminating a program, locking a keypad, locking a touch display, powering off a device, and/or the like, to be performed in response to a touch input by varying the contact associated with the touch input. Therefore, even between similar touch inputs, such as two touch inputs 520 of FIG. 5B, the apparatus may vary resulting operations based at least in part on the contact associated with the touch input. Information selection may relate to selecting text information, image information, file information, and/or the like. Information modification may relate to deleting, copying, moving, pasting, and/or the like. An operation for navigating a computer program may relate to a slide show, browser, hierarchical information management, and/or the like by displaying a previous screen, a next screen, and/or the like. An operation for displaying a virtual keypad may relate to showing a virtual keypad, hiding a virtual keypad, and/or the like.

In an example embodiment, a user delivers a touch input to an apparatus using a stylus tip, such as illustrated in FIG. 1A, for an operation, such as information selection, and delivers the same touch input with a finger tip, such as illustrated in FIGS. 1B and 1C, a stylus back, such as illustrated in FIG. 1F, a finger knuckle, such as illustrated in FIGS. 1D and 1E, and/or the like for a different operation, such as information modification. For example, the user may perform text selection by moving a stylus tip, as illustrated in FIG. 1A, on the touch display across the visual representation of the text, as illustrated in FIG. 5C, and perform an operation to move the text by placing a finger tip, as illustrated in FIG. 1C, on the touch display in relation to the visual representation of the selection, and moving the finger tip to a position to relocate the selection, as illustrated in FIG. 5B.

In another example embodiment, a user delivers a touch input to an apparatus using a finger tip, such as illustrated in FIG. 1B and 1C, a stylus back, such as illustrated in FIG. 1F, a finger knuckle, such as illustrated in FIGS. 1D and 1E, and/or the like for an operation, such as information selection, and delivers the same touch input with a finger pad, such as illustrated in FIGS. 1G and 1H, for a different operation, such as information modification. For example, the user may perform file selection by moving a finger tip, as illustrated in FIG. 1B, on the touch display across the visual representation of the files, as illustrated in FIG. 5B, and perform an operation to delete the files by placing the thumb pad, as illustrated in FIG. 1H, on the touch display in relation to the visual representation of the selection, and flicking the thumb pad, as illustrated in FIG. 5D.

In still another example embodiment, the user delivers a touch input to an apparatus using a finger pad, such as illustrated in FIGS. 1G and 1H, for an operation, such as navigating a computer program, and delivers the same touch input with a majority part of finger, such as illustrated in FIGS. 1I and 1J, for a different operation, such as displaying a virtual keypad, launching a computer program, terminating a computer program, and/or the like. For example, the user may perform navigation in a web browser to a previous web page by moving a finger pad on a touch display, as illustrated in FIG. 1G, to the left, similar as illustrated in FIG. 5B, and perform an operation to terminate the web browser program by moving the majority part of a finger, as illustrated in FIG. 1I, towards the bottom of the screen, as illustrated in FIG. 5D.

In an example embodiment, an apparatus may differentiate user contact based, at least in part, on a contact region associated with the touch input. For example, the contact region associated with a touch input corresponding to the contact of FIG. 1A may differ from the contact region associated with a touch input corresponding to the contact of FIG. 1B.

In an example embodiment, the apparatus may determine a type of input based at least in part on the size of a contact region. For example, the apparatus may determine a first type associated with a size of contact region, a second type associated with a second size of contact region, and/or the like.

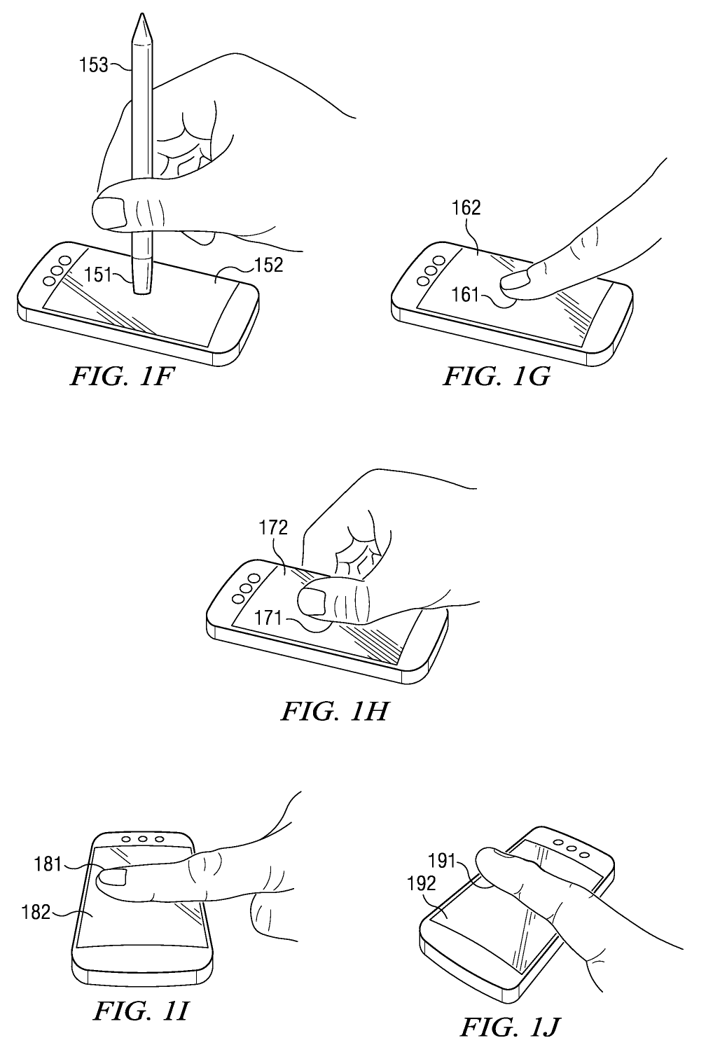

FIGS. 2A-2D are diagrams illustrating a contact region associated with a touch input. Although the contact regions of the examples of FIGS. 2A-2D illustrate elliptical regions, the shape of the contact region may vary and does not limit the invention. The examples of FIGS. 2A-2D illustrate contact regions in relation to a unit of measure 202. Unit of measure 202 merely illustrates the relative size of the various contact regions, and does not relate to any specific unit of measure. Therefore, unit of measure 202 does not limit the invention.

FIG. 2A is a diagram illustrating contact region 201 in relation to unit of measure 202. In an example embodiment, contact region 201 has a smaller height and width than unit of measure 202. In an example embodiment, contact region 201 is associated with a touch display contact, such as the contact illustrated in FIG. 1A. Contact region 201 may be associated with a touch input, such as touch input 500 of FIG. 5A.

FIG. 2B is a diagram illustrating contact region 211 in relation to unit of measure 202. In an example embodiment, contact region 211 is larger, with respect to unit of measure 202, than contact region 201 of FIG. 2A. In an example embodiment, contact region 211 is associated with a touch display contact, such as the contact illustrated in FIGS. 1B-1F. Contact region 211 may be associated with a touch input, such as touch input 520 of FIG. 5B.

FIG. 2C is a diagram illustrating contact region 221 in relation to unit of measure 202. In an example embodiment, contact region 221 is larger, with respect to unit of measure 202, than contact region 211 of FIG. 2B. In an example embodiment, contact region 221 is associated with a touch display contact, such as the contact illustrated in FIGS. 1G and 1H. Contact region 221 may be associated with a touch input, such as touch input 540 of FIG. 5C.

FIG. 2D is a diagram illustrating contact region 231 in relation to unit of measure 202. In an example embodiment, contact region 231 is larger, with respect to unit of measure 202, than contact region 221 of FIG. 2C. In an example embodiment, contact region 231 is associated with a touch display contact, such as the contact illustrated in FIGS. 1I and 1J. Contact region 231 may be associated with a touch input, such as touch input 560 of FIG. 5D.

In an example embodiment, an apparatus may vary operations performed in response to receiving a touch input based, at least in part, on the size of the contact region associated with the touch input.

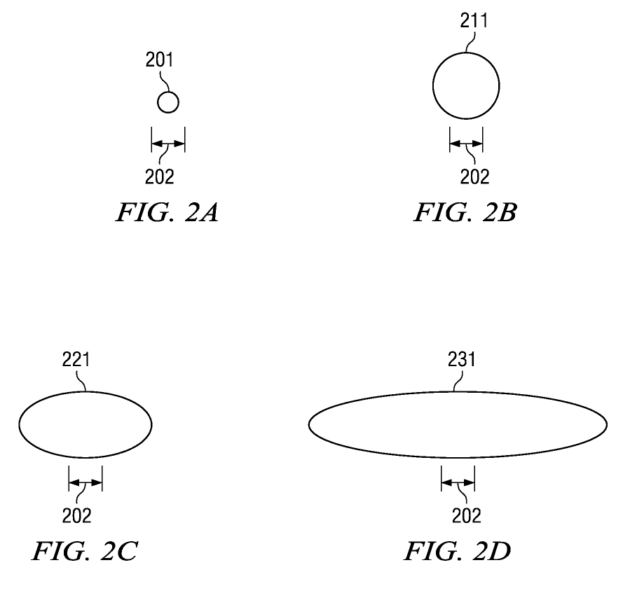

FIG. 3 is a flow diagram showing a set of operations 300 for performing operations based on touch inputs according to an example embodiment of the invention. An apparatus, for example electronic device 10 of FIG. 6, may perform or otherwise support the set of operations 300. The apparatus may comprise means, such as a processor, a computer program product or the like, for performing the operations of FIG. 3. In the example of FIG. 3, the designation of first and second are used to differentiate without regard any sequential ordering, if any, and do not limit the scope of the invention. For example, an apparatus may receive a first touch input before a second touch input, after a second touch input, concurrently with a second touch input, and/or the like. Additionally, reference will be made to receipt of a first touch input and receipt of a second touch input. Depending upon the portion of the apparatus to which reference is being made, receipt of the first and/or second touch inputs may refer to the receipt of the actual touch input, such as in instances in which reference is being made to the touch display, or receipt of an indication of, such as a signal generated by and indicative of, the touch input, such as in instances in which reference is being made to the processor. As used herein, reference to the receipt of a touch input is therefore intended to include both receipt of the actual touch input as well as receipt of an indication of a touch input. The indication of the touch input may comprise a signal, data, a data structure, a software class, and/or the like. The apparatus may receive the indication from hardware and/or software by signal, message, method call, function call, and/or the like.

At block 301, the apparatus receives a first touch input associated with a first contact region. The touch input may comprise position information, time information, speed information, and/or the like. A touch display, for example display 28, of FIG. 6, may receive the touch input. The apparatus may receive the touch input after the touch input terminates, before the touch input terminates, and/or the like. For example, the apparatus may receive the touch input while a user is performing the touch input. In another example, the apparatus may receive the touch input after the user has terminated a touch input. The apparatus may associate the first touch input with a contact region, such as illustrated in FIGS. 2A-2D, related to a user touch display contact, such as illustrated in FIGS. 1A-1J. For example, the first touch input may relate to touch input 500 of FIG. 5A, associated with contact region 211 of FIG. 2B, which may relate to a finger tip contact, such as illustrated in FIG. 1B and 1C, a finger knuckle such as illustrated in FIGS. 1D and 1E, a stylus back, such as in FIG. 1F, and/or the like. In still another example, the first touch input may relate to touch input 540 of FIG. 5C, associated with contact region 221 of FIG. 2C, which may relate to a finger pad contact, such as illustrated in FIGS. 1G and 1H. In yet another example, the first touch input may relate to a touch input, such as input 560 of FIG. 5D, associated with contact region 231 of FIG. 2D, which relates to a majority part of a finger, such as illustrated in FIGS. 1I and 1J.

At block 302, the apparatus performs a first operation based at least in part on the first touch input and size of the first contact region. For example, the first operation may relate to selecting information, such as selecting text information, image information, file information, and/or the like. In another example, the first operation may relate to information modification, such as deleting, copying, moving, pasting, and/or the like. In still another example, the first operation may relate to navigating a computer program such as a slide show, a browser, a file manager, and/or the like by displaying a previous screen, a next screen, and/or the like. In yet another example, the first operation may relate to displaying a virtual keypad, such as showing a virtual keypad, hiding a virtual keypad, and/or the like. In an additional example, the first operation may relate to starting a program, terminating a program, and/or the like.

In an example embodiment, the apparatus determines the size of a contact region, such as the first contact region and/or the second contact region, at least in part by calculating area of the contact region, width of the contact region, length of the contact region, and/or the like. In an example embodiment, the apparatus may utilize one or more criteria to determine a type associated with the size of the contact region.

In an example embodiment, an apparatus bases the first operation, at least in part, on a comparison of the first contact region and a threshold, for example a threshold relating to an area calculation. For example, the apparatus may perform an operation if the size of the first contact region is less than the threshold and perform a different operation if the size of the first contact region is greater than the threshold. There may be more than one threshold. For example, an apparatus may utilize a threshold relating to a size between the size of contact region 201 of FIG. 2A and the size of contact region 211 of FIG. 2B, and a different threshold relating to a size between the size of contact region 211 of FIG. 2B and the size of contact region 221 of FIG. 2C. In an example embodiment, the threshold is predetermined, modifiable, adaptable, and/or the like. For example, an apparatus may have one or more default thresholds. In another example, an apparatus may allow modification of one or more thresholds, such as through user action, program action, and/or the like. In still another example, an apparatus may adapt one or more thresholds, such as through a training process, receiving feedback, and/or the like.

In an example embodiment, an apparatus bases the first operation, at least in part, on a comparison of the first contact region and history information, for example information relating to one or more previous operations performed in association with one or more previous contact regions. For example, the apparatus may perform an operation if the size of the first contact region is similar to one set of history information and perform a different operation if the size of the first contact region is similar to a different set of history information. In such an example, the first operation may be based, at least in part, on a contact region being similar to a set of history information. There may be more than one set of history information. For example, an apparatus may have history information relating to contact region 201 of FIG. 2A, different set of history information relating to contact region 211 of FIG. 2B, and a different set of history information relating to contact region 221 of FIG. 2C. In an example embodiment, the history information is predetermined, modifiable, adaptable, and/or the like. For example, an apparatus may have one or more default history information sets, for example to allow determination of contact region type before the apparatus receives any input for the first time. In another example, an apparatus may allow modification of one or more sets of history information, such as through accumulating information regarding user action, program action, and/or the like. In still another example, an apparatus may adapt one or more sets of history information, such as through a training process, receiving feedback, and/or the like.

At block 303, the apparatus receives a second touch input associated with a second contact region. The receiving, touch input and contact region may be similar as described with reference to block 301. In an example embodiment, the second touch input may be of the same type as the first touch input. For example, the first touch input and the second touch input may be similar to touch input 520 of FIG. 5B. In another example, the first touch input and the second touch input may be similar to touch input 540 of FIG. 5C.

At block 305, the apparatus performs a second operation based at least in part on the second touch input and the second contact region. The operation may be similar as described with reference to block 302. In an example embodiment, the first operation differs from the second operation. For example, the first operation may relate to text selection, and the second operation may relate to moving the selected text. In another example, the first operation may relate to scrolling a screen, and the second operation may relate to displaying a previously displayed screen.

In an example embodiment, the first operation, and/or the second operation preserve at least one user environment attribute, such as icon size, font size, virtual key size, screen orientation, and/or the like. For example, the second operation may relate to an operation that does not change any user environment attribute. In another example, the first user operation may relate to an operation that does not change any user environment attribute. In yet another example embodiment, the first user operation may modify virtual key size, but preserve font size.

In an example embodiment, an apparatus differentiates among three different sizes of contact regions. For example, an apparatus may perform an operation associated with contact region 201 of FIG. 2A, a different operation associated with contact region 211 of FIG. 2B, and a further different operation associated with contact region 221 of FIG. 2C. In another example, an apparatus may perform an operation associated with contact region 201 of FIG. 2A and contact region 211 of FIG. 2B, a different operation associated with contact region 221 of FIG. 2C, and a further different operation associated with contact region 231 of FIG. 2D.

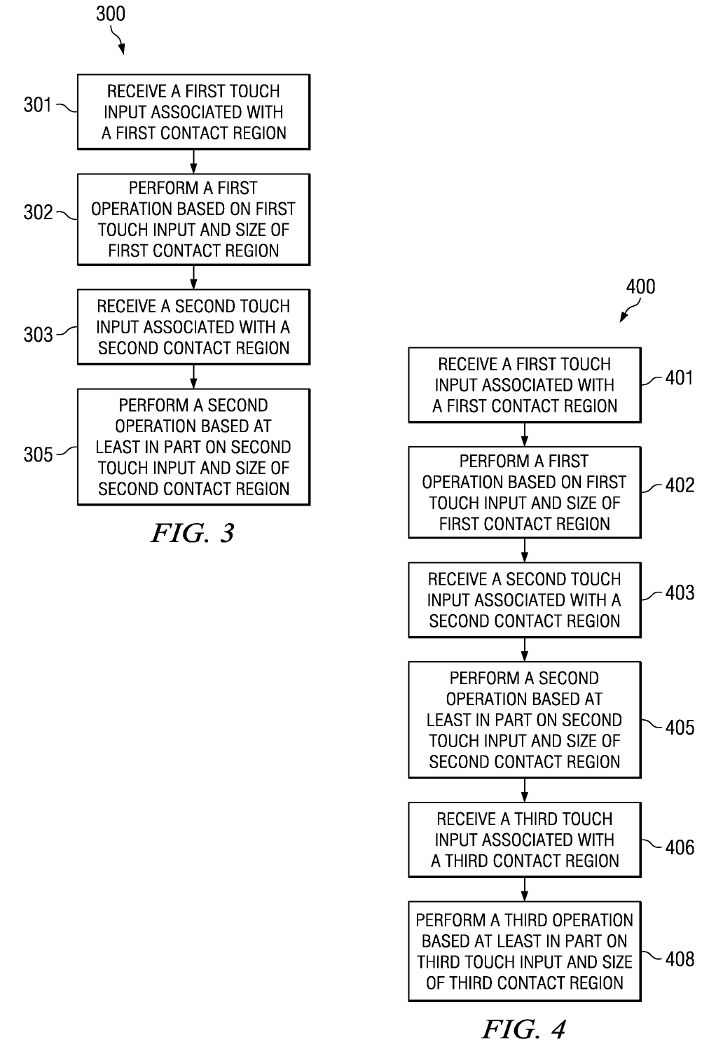

FIG. 4 is a flow diagram showing another set of operations 400 for performing operations based on touch inputs according to an example embodiment of the invention. An apparatus, for example electronic device 10 of FIG. 6, may utilize the set of operations 400. The apparatus may comprise means, such as a processor, a computer program product or the like, for performing the operations of FIG. 4. In the example of FIG. 4, the designation of first, second, and third are used to differentiate without regard any sequential ordering, if any, and do not limit the scope of the invention. For example, an apparatus may receive a first touch input before a second touch input, after a second touch input, concurrently with a second touch input, and/or the like.

At block 401, the apparatus receives a first touch input associated with a first contact region. The receiving, touch input, and contact region may be similar as described with reference to block 301 of FIG. 3.

At block 402, the apparatus performs a first operation based at least in part on the first touch input and size of the first contact region. The operation may be similar as described with reference to block 302 of FIG. 3.

At block 403, the apparatus receives a second touch input associated with a second contact region. The receiving, touch input and contact region may be similar as described with reference to block 301 of FIG. 3.

At block 405, the apparatus performs a second operation based at least in part on the second touch input and the second contact region. The operation may be similar as described with reference to block 305 of FIG. 3.

At block 406, the apparatus receives a third touch input associated with a third contact region. The receiving, touch input and contact region may be similar as described with reference to block 301 of FIG. 3.

At block 408, the apparatus performs a third operation based at least in part on the third touch input and size of the third contact region. The operation may be similar as described with reference to block 305 of FIG. 3.

FIGS. 5A-5E are diagrams illustrating input from a touch display, for example from display 28 of FIG. 6, according to an example embodiment of the invention. In FIGS. 5A-5E, a circle represents an input related to contact with a touch display, two crossed lines represent an input related to releasing a contact from a touch display, and a line represents input related to movement on a touch display.

In the example of FIG. 5A, input 500 relates to receiving contact input 502 and receiving a release input 504. In this example, contact input 502 and release input 504 occur at the same position. In an example embodiment, an apparatus utilizes the time between receiving contact input 502 and release input 504. For example, the apparatus may interpret input 500 as a tap for a short time between contact input 502 and release input 504, as a press for a longer time between contact input 502 and release input 504, and/or the like. In such an example, a tap input may induce one operation, such as selecting an item, and a press input may induce another operation, such as performing an operation on an item. In another example, a tap and/or press may relate to a user selected text position.

In the example of FIG. 5B, input 520 relates to receiving contact input 522, a movement input 524, and a release input 526. In this example, contact input 522 and release input 526 occur at different positions. Input 520 may relate to dragging an object from one position to another, to moving a scroll bar, to panning a virtual screen, to drawing a shape, and/or the like. In an example embodiment, an apparatus interprets input 520 based at least in part on the speed of movement 524. For example, if input 520 relates to panning a virtual screen, the panning motion may be small for a slow movement, large for a fast movement, and/or the like. In another example embodiment, an apparatus interprets input 520 based at least in part on the distance between contact input 522 and release input 526. For example, if input 520 relates to a scaling operation, such as resizing a box, the scaling may relate to the distance between contact input 522 and release input 526. An apparatus may interpret the input before receiving release input 526. For example, the apparatus may evaluate a change in the input, such as speed, position, and/or the like. In such an example, the apparatus may perform one or more determinations based upon the change in the touch input. In such an example, the apparatus may modify a text selection point based at least in part on the change in the touch input.

In the example of FIG. 5C, input 540 relates to receiving contact input 542, a movement input 544, and a release input 546 as shown. In this example, contact input 542 and release input 546 occur at different positions. Input 540 may relate to dragging an object from one position to another, to moving a scroll bar, to panning a virtual screen, to drawing a shape, and/or the like. In an example embodiment, an apparatus interprets input 540 based at least in part on the speed of movement 544. For example, if input 540 relates to panning a virtual screen, the panning motion may be small for a slow movement, large for a fast movement, and/or the like. In another example embodiment, an apparatus interprets input 540 based at least in part on the distance between contact input 542 and release input 546. For example, if input 540 relates to a scaling operation, such as resizing a box, the scaling may relate to the distance between contact input 542 and release input 546. In still another example embodiment, the apparatus interprets the position of the release input. In such an example, the apparatus may modify a text selection point based at least in part on the change in the touch input.

In the example of FIG. 5D, input 560 relates to receiving contact input 562, and a movement input 564, where contact is released during movement. Input 560 may relate to dragging an object from one position to another, to moving a scroll bar, to panning a virtual screen, to drawing a shape, and/or the like. In an example embodiment, an apparatus interprets input 560 based at least in part on the speed of movement 564. For example, if input 560 relates to panning a virtual screen, the panning motion may be small for a slow movement, large for a fast movement, and/or the like. In another example embodiment, an apparatus interprets input 560 based at least in part on the distance associated with the movement input 564. For example, if input 560 relates to a scaling operation, such as resizing a box, the scaling may relate to the distance of the movement input 564 from the contact input 562 to the release of contact during movement.

In an example embodiment, an apparatus may receive multiple touch inputs at coinciding times. For example, there may be a tap input at a position and a different tap input at a different location during the same time. In another example there may be a tap input at a position and a drag input at a different position. An apparatus may interpret the multiple touch inputs separately, together, and/or a combination thereof. For example, an apparatus may interpret the multiple touch inputs in relation to each other, such as the distance between them, the speed of movement with respect to each other, and/or the like.

In the example of FIG. 5E, input 580 relates to receiving contact inputs 582 and 588, movement inputs 584 and 590, and release inputs 586 and 592. In this example, contact input 582 and 588, and release input 586 and 592 occur at different positions. Input 580 may be characterized as a multiple touch input. Input 580 may relate to dragging an object from one position to another, to moving a scroll bar, to panning a virtual screen, to drawing a shape, to indicating one or more user selected text positions and/or the like. In an example embodiment, an apparatus interprets input 580 based at least in part on the speed of movements 584 and 590. For example, if input 580 relates to zooming a virtual screen, the zooming motion may be small for a slow movement, large for a fast movement, and/or the like. In another example embodiment, an apparatus interprets input 580 based at least in part on the distance between contact inputs 582 and 588 and release inputs 586 and 592. For example, if input 580 relates to a scaling operation, such as resizing a box, the scaling may relate to the collective distance between contact inputs 582 and 588 and release inputs 586 and 592.

In an example embodiment, the timing associated with the apparatus receiving contact inputs 582 and 588, movement inputs 584 and 590, and release inputs 586 and 592 varies. For example, the apparatus may receive contact input 582 before contact input 588, after contact input 588, concurrent to contact input 588, and/or the like. The apparatus may or may not utilize the related timing associated with the receiving of the inputs. For example, the apparatus may utilize an input received first by associating the input with a preferential status, such as a primary selection point, a starting position, and/or the like. In another example, the apparatus may utilize non-concurrent inputs as if the apparatus received the inputs concurrently. In such an example, the apparatus may utilize a release input received first the same way that the apparatus would utilize the same input if the apparatus had received the input second.

Even though an aspect related to two touch inputs may differ, such as the direction of movement, the speed of movement, the position of contact input, the position of release input, and/or the like, the touch inputs may be similar. For example, a first touch input comprising a contact input, a movement input, and a release input, may be similar to a second touch input comprising a contact input, a movement input, and a release input, even though they may differ in the position of the contact input, and the position of the release input.

FIG. 6 is a block diagram showing an apparatus, such as an electronic device 10, according to an example embodiment of the invention. It should be understood, however, that an electronic device as illustrated and hereinafter described is merely illustrative of an electronic device that could benefit from embodiments of the present invention and, therefore, should not be taken to limit the scope of the present invention. While one embodiment of the electronic device 10 is illustrated and will be hereinafter described for purposes of example, other types of electronic devices, such as, but not limited to, portable digital assistants (PDAs), pagers, mobile computers, desktop computers, televisions, gaming devices, laptop computers, cameras, video recorders, global positioning system (GPS) devices and other types of electronic systems, may readily employ embodiments of the present invention.

Furthermore, devices may readily employ embodiments of the present invention regardless of their intent to provide mobility. In this regard, even though embodiments of the present invention are described in conjunction with mobile communications applications, it should be understood that embodiments of the present invention may be utilized in conjunction with a variety of other applications, both in the mobile communications industries and outside of the mobile communications industries.

The electronic device 10 may comprise an antenna 12 (or multiple antennae) in operable communication with a transmitter 14 and a receiver 16. The electronic device 10 may further comprise a processor 20 or other processing element that provides signals to and receives signals from the transmitter 14 and receiver 16, respectively. The signals may comprise signaling information in accordance with a communications interface standard, user speech, received data, user generated data, and/or the like. The electronic device 10 may operate with one or more air interface standards, communication protocols, modulation types, and access types. By way of illustration, the electronic device 10 may operate in accordance with any of a number of first, second, third and/or fourth-generation communication protocols or the like. For example, the electronic device 10 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), or with fourth-generation (4G) wireless communication protocols, wireless networking protocols, such as 802.11, short-range wireless protocols, such as Bluetooth, and/or the like.

Processor 20 may comprise means, such as circuitry for implementing audio, video, communication, navigation, logic functions, and or the like, as well as for implementing embodiments of the present invention including, for example, one or more of the functions described in conjunction with FIGS. 3-5. For example, processor 20 may comprise means, such as one or more digital signal processor devices, microprocessor devices, various analog to digital converters, digital to analog converters, and other support circuits, for performing various functions including, for example, one or more of the functions described in conjunction with FIGS. 3-5. The apparatus may perform control and signal processing functions of the electronic device 10 among these devices according to their respective capabilities. The processor 20 thus may comprise the functionality to encode and interleave message and data prior to modulation and transmission. The processor 20 may additionally comprise an internal voice coder, and may comprise an internal data modem. Further, the processor 20 may comprise functionality to operate one or more software programs, which may be stored in memory and which may, among other things, cause the processor 20 to implement at least one embodiment of the invention including, for example, one or more of the functions described in conjunction with FIGS. 3-5. For example, the processor 20 may operate a connectivity program, such as a conventional internet browser. The connectivity program may allow the electronic device 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic device 10 may comprise a user interface for providing output and/or receiving input. The electronic device 10 may comprise an output device such as a ringer, a conventional earphone and/or speaker 24, a microphone 26, a display 28, and/or a user input interface, which are coupled to the processor 20. The user input interface, which allows the electronic device 10 to receive data, may comprise one or more devices that may allow the electronic device 10 to receive data, such as a keypad 30, a touch display, for example if display 28 comprises touch capability, and/or the like. In an embodiment comprising a touch display, the touch display may be configured to receive input from a single point of contact, multiple points of contact, and/or the like. In such an embodiment, the touch display may determine input based on position, motion, speed, contact area, and/or the like.

The electronic device 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display.

In embodiments including the keypad 30, the keypad 30 may comprise numeric (for example, 0-9) keys, symbol keys (for example, #, *), alphabetic keys, and/or the like for operating the electronic device 10. For example, the keypad 30 may comprise a conventional QWERTY keypad arrangement. The keypad 30 may also comprise various soft keys with associated functions. In addition, or alternatively, the electronic device 10 may comprise an interface device such as a joystick or other user input interface. The electronic device 10 further comprises a battery 34, such as a vibrating battery pack, for powering various circuits that are required to operate the electronic device 10, as well as optionally providing mechanical vibration as a detectable output.

In an example embodiment, the electronic device 10 comprises a media capturing element, such as a camera, video and/or audio module, in communication with the processor 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 may comprise hardware, such as a lens or other optical component(s), and/or software necessary for creating a digital image file from a captured image. Alternatively, the camera module 36 may comprise only the hardware for viewing an image, while a memory device of the electronic device 10 stores instructions for execution by the processor 20 in the form of software for creating a digital image file from a captured image. In an example embodiment, the camera module 36 may further comprise a processing element such as a co-processor that assists the processor 20 in processing image data and an encoder and/or decoder for compressing and/or decompressing image data. The encoder and/or decoder may encode and/or decode according to a standard format, for example, a Joint Photographic Experts Group (JPEG) standard format.

The electronic device 10 may comprise one or more user identity modules (UIM) 38. The UIM may comprise information stored in memory of electronic device 10, a part of electronic device 10, a device coupled with electronic device 10, and/or the like. The UIM 38 may comprise a memory device having a built-in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a subscriber, an operator, a user account, and/or the like. For example, UIM 38 may store subscriber information, message information, contact information, security information, program information, and/or the like. Usage of one or more UIM 38 may be enabled and/or disabled. For example, electronic device 10 may enable usage of a first UIM and disable usage of a second UIM.

In an example embodiment, electronic device 10 comprises a single UIM 38. In such an embodiment, at least part of subscriber information may be stored on the UIM 38.

In another example embodiment, electronic device 10 comprises a plurality of UIM 38. For example, electronic device 10 may comprise two UIM 38 blocks. In such an example, electronic device 10 may utilize part of subscriber information of a first UIM 38 under some circumstances and part of subscriber information of a second UIM 38 under other circumstances. For example, electronic device 10 may enable usage of the first UIM 38 and disable usage of the second UIM 38. In another example, electronic device 10 may disable usage of the first UIM 38 and enable usage of the second UIM 38. In still another example, electronic device 10 may utilize subscriber information from the first UIM 38 and the second UIM 38.

Electronic device 10 may comprise one or more memory devices including, in one embodiment, volatile memory 40, such as volatile Random Access Memory (RAM) including a cache area for the temporary storage of data. The electronic device 10 may also comprise other memory, for example, non-volatile memory 42, which may be embedded and/or may be removable. The non-volatile memory 42 may comprise an EEPROM, flash memory or the like. The memories may store any of a number of pieces of information, and data. The information and data may be used by the electronic device 10 to implement one or more functions of the electronic device 10, such as the functions described in conjunction with FIGS. 4-6. For example, the memories may comprise an identifier, such as an international mobile equipment identification (IMEI) code, which may uniquely identify the electronic device 10.

Although FIG. 6 illustrates an example of an electronic device that may utilize embodiments of the present invention including those described and depicted, for example, in FIGS. 3-5, electronic device 10 of FIG. 6 is merely an example of a device that may utilize embodiments of the present invention.

Without in any way limiting the scope, interpretation, or application of the claims appearing below, a technical effect of one or more of the example embodiments disclosed herein is reducing processor operations by allowing a user to provide fewer touch inputs to perform an operation by modifying the contact region associated with the touch inputs. Another technical effect of one or more of the example embodiments disclosed herein is reducing the amount of time a processor spends awaiting user input.

Embodiments of the present invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media. In the context of this document, a “computer-readable medium” may be any media or means that can contain, or store the instructions for use by or in connection with an instruction execution system, apparatus, or device, such as a computer, with one example of a computer described and depicted in FIG. 6. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising a processor configured to cause the apparatus to:
receive an indication of a first touch input associated with a first contact region;
perform a first operation based at least in part on both said first touch input and size of said first contact region;
receive an indication of a second touch input associated with a second contact region; and
perform a second operation based at least in part on both said second touch input and size of said second contact region.

2. The apparatus of claim 1, wherein said first contact region relates to a stylus tip and said second contact region relates to a fingertip.

3. The apparatus of claim 1, wherein said first contact region relates to a finger tip and said second contact region relates to a finger pad.

4-52. (canceled)

53. The apparatus of claim 1, wherein said processor is configured to calculate at least one of size of said first contact region and size of said second contact region based on area.

54. The apparatus of claim 1, wherein said processor is configured to base, at least in part, at least one of said first operation or said second operation on a comparison between a threshold and said first contact region or said second contact region, respectively.

55. The apparatus of claim 1, wherein said processor is configured to base, at least in part, at least one of said first operation or said second operation on a comparison between history information and said first contact region or said second contact region, respectively.

56. The apparatus of claim 1, wherein said first touch input is the same type as said second touch input.

57. The apparatus of claim 1, wherein at least one of said first operation or said second operation relates to selecting information.

58. The apparatus of claim 1, wherein at least one of said first operation or said second operation relates to modifying information.

59. The apparatus of claim 58, wherein said modifying information relates to deleting information.

60. The apparatus of claim 58, wherein said modifying information relates to copying information.

61. The apparatus of claim 1, wherein at least one of said first operation or said second operation relates to displaying a virtual keypad.

62. The apparatus of claim 1, wherein at least one of said first operation or said second operation relates to at least one of starting a computer program or terminating a computer program.

63. The apparatus of claim 1-, wherein at least one of said first operation or said second operation relates to navigating a computer program.

64. The apparatus of claim 1, wherein at least one of said first operation and said second operation preserve at least one user environment attribute.

65. The apparatus of claim 64, wherein said first operation differs from said second operation.

66. The apparatus of claim 1, wherein said processor is further configured to:
receive a third touch input associated with a third contact region; and
perform a third operation based at least in part on both said third touch input and size of said third contact region.

67. The apparatus of claim 1, wherein the processor comprises at least one memory that contains executable instructions that if executed by the processor cause the apparatus to:
receive an indication of a first touch input associated with a first contact region;
perform a first operation based at least in part on both said first touch input and size of said first contact region;
receive an indication of a second touch input associated with a second contact region; and
perform a second operation based at least in part on both said second touch input and size of said second contact region.

68. A method, comprising:
receiving an indication of a first touch input associated with a first contact region;
performing a first operation based at least in part on both said first touch input and size of said first contact region;
receiving an indication of a second touch input associated with a second contact region; and
performing a second operation based at least in part on both said second touch input and size of said second contact region.

69. A computer-readable medium encoded with instructions that, when executed by a computer, perform:
receiving an indication of a first touch input associated with a first contact region;
performing a first operation based at least in part on both said first touch input and size of said first contact region;
receiving an indication of a second touch input associated with a second contact region; and
performing a second operation based at least in part on both said second touch input and size of said second contact region.
